(19) United States
(12) Patent Application Publication
(10) Pub. No.: US 2013/0045724 A1
(43) Pub. Date: Feb. 21, 2013

(54) APPARATUS AND METHOD FOR PROVIDING MULTI COMMUNICATION SERVICE IN MOBILE COMMUNICATION TERMINAL

(71) Applicant: Hyo-Seok Na, Suwon-si (KR)

(72) Inventor: Hyo-Seok Na, Suwon-si (KR)

(73) Assignee: SAMSUNG ELECTRONICS CO., LTD., Suwon-si (KR)

(21) Appl. No.: 13/587,721

(22) Filed: Aug. 16, 2012

(30) Foreign Application Priority Data
Aug. 16, 2011 (KR) 10-2011-0081144

(51) Int. Cl. H04W 4/00; G10L 19/00

(52) U.S. Cl. 455/414.1; 704/201; 704/E19.001

(57) ABSTRACT

An apparatus and a method provide a multi-communication service in a mobile communication terminal. The apparatus includes a microphone for inputting an audio signal and a speaker for outputting an audio signal. The apparatus also includes a plurality of communication modules for transmitting and receiving signals to and from a plurality of counterpart terminals. The apparatus further includes an audio processor for, when the multi-communication service is provided, combining and outputting at least two of audio signals fed from the counterpart terminals providing the multi-communication service and the audio signal input through the microphone.

### CROSS-REFERENCE TO RELATED APPLICATION(S) AND CLAIM OF PRIORITY

The present application is related to and claims the benefit under 35 U.S.C. §119(a) to a Korean patent application filed in the Korean Intellectual Property Office on Aug. 16, 2011, and assigned Serial No. 10-2011-0081144, the entire disclosure of which is hereby incorporated by reference.

### TECHNICAL FIELD OF THE INVENTION

The present disclosure relates to an apparatus and a method for providing a multi-communication service in a mobile communication terminal.

### BACKGROUND OF THE INVENTION

As voice communication services using a terminal are widely used, some wireless communication systems provide not only one-to-one communication but also multi-communication services for simultaneous communication between three parties. For example, for a simultaneous call with a user of a third terminal during a one-to-one call between a first terminal and a second terminal, a multi-communication service may connect the call to the third terminal while maintaining the call with the second terminal. In so doing, the wireless communication system may provide the multi-communication service using a separate server for the multi-communication service.

Recently, as Internet and wireless Local Area Network (LAN) technologies advance, Internet telephony service using the Internet, rather than a mobile phone network, has gained in popularity. For example, in an Internet telephony service, a caller terminal converts a voice signal of the caller to a digital signal and sends the digital signal to a receiver terminal over the Internet. The receiver terminal converts the digital signal received from the caller terminal to the voice signal and provides the voice signal to a receiver.

As discussed above, the mobile communication terminal can provide the communication using, the mobile phone network and the communication using the Internet. However, the communication using the mobile phone network and the communication using the Internet work independently. Accordingly, the wireless communication system cannot provide the multi-communication service to the user using both of the mobile phone network and the Internet.

### SUMMARY OF THE INVENTION

To address the above-discussed deficiencies of the prior art, it is a primary aspect of the present disclosure to provide an apparatus and a method for providing a multi-communication service in a mobile communication terminal.

Another aspect of the present disclosure is to provide an apparatus and a method for providing a multi-communication service using heterogeneous networks in a mobile communication terminal.

Yet another aspect of the present disclosure is to provide an apparatus and a method for providing a multi-communication service using a mobile phone network and the Internet in a mobile communication terminal.

Still another aspect of the present disclosure is to provide an apparatus and a method for providing a multi-communication service with a second terminal using a mobile phone network and a third terminal using the Internet in a mobile communication terminal.

A further aspect of the present disclosure is to provide an apparatus and a method for providing a three-party communication service for terminals using heterogeneous networks in a mobile communication terminal.

According to one aspect of the present disclosure, an apparatus for providing a multi-communication service in a mobile communication terminal includes a microphone configured to input an audio signal. The apparatus also includes a speaker configured to output an audio signal. The apparatus further includes a plurality of communication modules configured to transmit and receive signals to and from a plurality of counterpart terminals. The apparatus still further includes an audio processor configured to, when the multi-communication service is provided, combine and output a plurality of audio signals fed from the counterpart terminals providing the multi-communication service and the audio signal input through the microphone.

According to another aspect of the present disclosure, a method for providing a multi-communication service in a mobile communication terminal is provided. The method includes, when the multi-communication service is provided, connecting calls with a plurality of counterpart terminals using a plurality of communication modules. The method also includes combining at least two of an audio signal input through a microphone and audio signals fed from the counterpart terminals and sending the combined audio signal to the counterpart terminals.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless communication system according to an embodiment of the present disclosure;

FIG. 2 illustrates a mobile communication terminal according to an embodiment of the present disclosure;

FIG. 3 illustrates a method for providing a multi-communication service in the mobile communication terminal according to an embodiment of the present disclosure; and

FIG. 4 illustrates a method for providing the multi-communication service in the mobile communication terminal according to another embodiment of the present disclosure.

Throughout the drawings, like reference numerals will be understood to refer to like parts, components and structures.

### DETAILED DESCRIPTION OF THE INVENTION

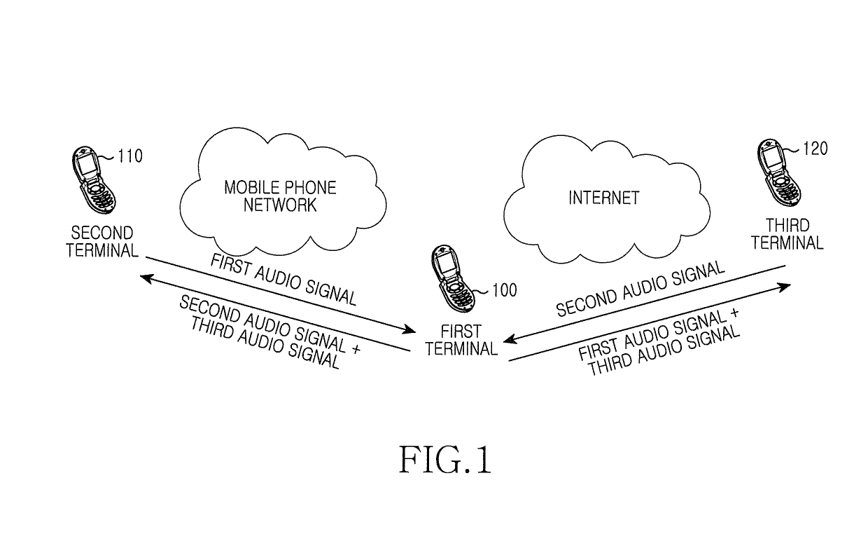

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing, from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present disclosure provide a technique for providing a multi-communication service in a mobile communication terminal.

Hereinafter, it is assumed that the mobile communication terminal provides the multi-communication service with counterpart terminals using heterogeneous networks.

In the multi-communication service using the heterogeneous networks, the mobile communication terminal can connect the call with at least two counterpart terminals over at least two heterogeneous networks at the same time. Hereafter, it is assumed that the mobile communication terminal provides the multi-communication service with a counterpart terminal using a mobile phone network and a counterpart terminal using the Internet. Notably, the mobile communication terminal can provide the multi-communication service with a plurality of counterpart terminals using the mobile phone network and a plurality of counterpart terminals using the Internet in the same manner.

FIG. 1 depicts a wireless communication system according to an embodiment of the present disclosure.

As shown in FIG. 1, the wireless communication system includes a plurality of terminals 100, 110, and 120. Herein, the first terminal 100 is assumed to provide the communication using the mobile phone network and the Internet. Accordingly, the first terminal 100 is assumed to communicate with the second terminal 110 using the mobile phone network and to communicate with the third terminal 120 using the Internet.

When the third terminal 120 requests the call connection to the first terminal 100 which is communicating with the second terminal 110, the first terminal 100 connects the call with the third terminal 120 using the Internet while maintaining the call connection with the second terminal 110. That is, the first terminal 100 provides the multi-communication service using the mobile phone network and the Internet. Herein, the mobile phone network includes at least one of a second-generation (2G) network, a third-generation (3G) network and a fourth-generation (4G) network, and the Internet includes at least one of the 3G network, the 4G network, and a wireless Local Area Network (LAN). The 2G network includes a Code Division Multiple Access (CDMA) system, a Global System for Mobile Communications (GSM) system, and the like. The 3G network includes a Wideband CDMA (WCDMA) system, a CDMA 2000 system, a High Speed Downlink Packet Access (HSDPA) system, and a High Speed Uplink Packet Access (HSUPA) system. The 4G network includes a Long Term Evolution (LTE) system and a Wibro system.

When the second terminal 110 requests the call connection to the first terminal 100 which is communicating with the third terminal 120, the first terminal 100 connects the call with the second terminal 110 using the mobile phone network while maintaining, the call connection with the third terminal 120. That is, the first terminal 100 provides the multi-communication service using the mobile phone network and the Internet.

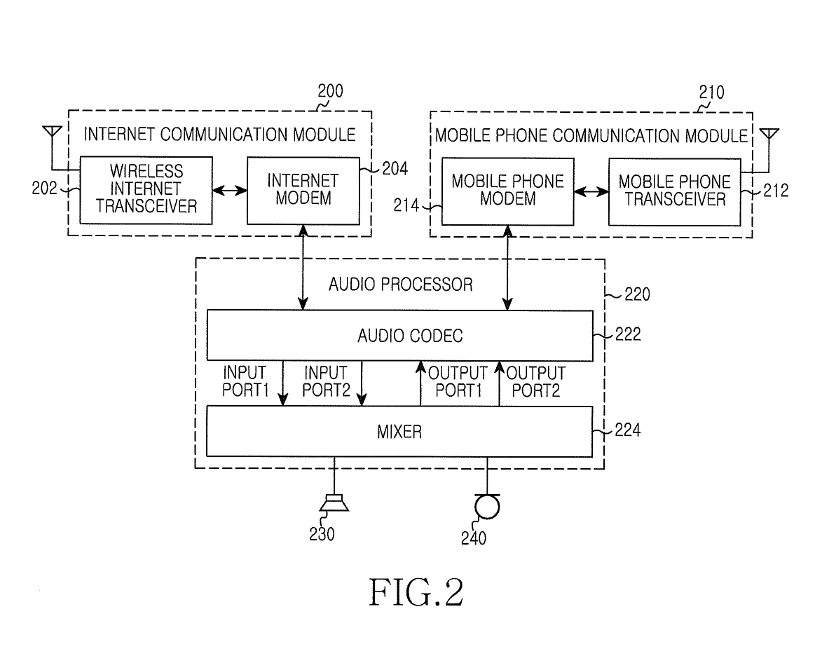

In the multi-communication service with the terminals 100, 110, and 120 as explained above, the first terminal 100 combines and outputs audio signals of the terminals 100, 110, and 120. For example, when receiving a first audio signal from the second terminal 110, a second audio signal from the third terminal 120, and a third audio signal through a microphone, the first terminal 100 combines and sends the first audio signal and the third audio signal to the third terminal 120. The first terminal 100 combines and sends the second audio signal and the third audio signal to the second terminal 110, and combines and outputs the first audio signal and the second audio signal through a speaker. To provide the multi-communication service by combining the audio signals, the first terminal 100 can be constructed as shown in FIG. 2.

FIG. 2 is a block diagram of a mobile communication terminal according to an embodiment of the present disclosure.

As shown in FIG. 2, the mobile communication terminal includes an Internet communication module 200, a mobile phone communication module 210, and an audio processor 220. Herein, the Internet communication module 200 and the mobile phone communication module 210 operate independently. That is, the Internet communication module 200 and the mobile phone communication module 210 do not exert an influence mutually.

The Internet communication module 200 transmits and receives voice data over the Internet for the Internet telephony service with the counterpart terminal. For example, the first terminal 100 of FIG. 1 transmits and receives voice data to and from the third terminal 120 using the Internet communication module 200.

The Internet communication module 200 includes a wireless Internet transceiver 202 and an Internet modem 204. Herein, the wireless Internet transceiver 202 processes signals transmitted and received over the Internet. The Internet modem 204 demodulates and decodes the signal fed from the wireless Internet transceiver 202. The Internet modem 204 encodes and modulates the signal to transmit through the wireless Internet transceiver 202 and provides the encoded and modulated signal to the wireless Internet transceiver 202.

The mobile phone communication module 210 transmits and receives voice data over the mobile phone network for the mobile phone service with the counterpart terminal. For example, the first terminal 100 of FIG. 1 transmits and receives voice data to and from the second terminal 110 using the mobile phone communication module 210.

The mobile phone communication module 210 includes a mobile phone transceiver 212 and a mobile phone modem 214. Herein, the mobile phone transceiver 212 processes signals transmitted and received over the mobile phone network. The mobile phone modem 214 demodulates and decodes the signal fed from the mobile phone transceiver 212. The mobile phone modem 214 encodes and modulates the signal to transmit through the mobile phone transceiver 212 and provides the encoded and modulated signal to the mobile phone transceiver 212.

The audio processor 220 converts the voice data fed from the Internet communication module 200 and the mobile phone communication module 210 to the audio signal and sends the audio signal to the outside through a speaker 230. The audio processor 220 converts the audio signal input through a microphone 240 to the voice data and sends the voice data to at least one of the Internet communication module 200 and the mobile phone communication module 210.

The audio processor 220 includes an audio codec 222 and a mixer 224. The audio codec 222 converts the voice data output from the Internet communication module 200 and the mobile phone communication module 210 to the audio signal, and converts the audio signal to transmit to the counterpart terminal, to the voice data.

The mixer 224 combines the plurality of the audio signals into one audio signal and outputs the single audio signal.

The mixer 224 combines the audio signals of the counterpart terminals and the audio signal fed through the microphone 240 and outputs the combined audio signal for the multi-communication service. In so doing, the mixer 224 can classify the type of the audio signal based on an input port. For example, when receiving the second audio signal from the Internet communication module 200 through a first port and the first audio signal from the mobile phone communication module 210 through a second port, the mixer 224 combines the first audio signal and the second audio signal and outputs the combined audio signal to the outside through the speaker 230. That is, the mixer 224 combines the voice signals of the user communicating over the Internet and the user communicating over the mobile phone network to the single audio signal and outputs the audio signal to the outside through the speaker 230 for the multi-communication service.

When receiving the third audio signal through the microphone 240, the mixer 224 combines the second audio signal and the third audio signal and thus generates the audio signal to transmit to the mobile phone communication module 210 for the multi-communication service. That is, the mixer 224 combines the voice signal of the user communicating over the Internet and the user voice signal input through the microphone 240 and thus generates the audio signal to transmit to the user communicating over the mobile phone network for the multi-communication service.

The mixer 224 generates the audio signal to send to the Internet communication module 200 by combining the first audio signal and the third audio signal for the multi-communication service. That is, the mixer 224 generates the audio signal to transmit to the user communicating over the Internet by uniting the voice signal of the user communicating over the mobile phone network and the user voice signal input through the microphone 240 for the multi-communication service.

The mobile communication terminal can further include a controller, which is not shown, for controlling the operations of the mobile communication terminal.

The controller controls the call connection using the Internet communication module 200 and the mobile phone communication module 210. For example, when a call event over the Internet occurs during the communication with the second terminal through the mobile phone communication module 210, the controller checks whether to provide the multi-communication service.

When providing the multi-communication service, the controller controls to connect the call with the third terminal through the Internet communication module 200 while maintaining the call connection with the second terminal. In so doing, the controller controls the mixer 224 to combine the plurality of the audio signals for the multi-communication service.

By contrast, when not providing the multi-communication service, the controller identifies the terminal the user wants to connect the call with. Next, the controller controls to connect the call with the terminal the user wants to connect the call with, using only one of the Internet communication module 200 and the mobile phone communication module 210.

For example, when a call event over the mobile phone network takes place while communicating with the third terminal over the Internet communication module 200, the controller determines whether to provide the multi-communication service.

When providing the multi-communication service, the controller controls to connect the call to the second terminal through the mobile phone communication module 210 while maintaining the call connection with the third terminal. In so doing, the controller controls the mixer 224 to combine the plurality of the audio signals for the multi-communication service.

By contrast, when not providing the multi-communication service, the controller identifies the terminal the user wants to connect the call with. Next, the controller controls to connect the call with the terminal the user wants to connect the call with, using only one of the Internet communication module 200 and the mobile phone communication module 210.

In this embodiment, the mobile communication terminal includes the Internet modem 204 and the mobile phone modem 214. Yet, the mobile communication terminal may include the Internet modem 204 and the mobile phone modem 214 as a single module.

The mobile communication terminal provides the multi-communication service among the user communicating over the Internet, the user communicating over the mobile phone network, and the user of the mobile communication terminal. When the mobile communication terminal includes a communication module other than the Internet communication module 200 and the mobile phone communication module 210, the mobile communication terminal can provide the multi-communication service of at least two of the user communicating over the Internet, the user communicating over the mobile phone network, the user of the mobile communication terminal, and the user connectable through the other communication module.

In this embodiment, the mobile communication terminal provides the multi-communication service by connecting the call with any one counterpart terminal over the Internet using the Internet communication module 200 and connecting the call with any one counterpart terminal over the mobile phone network using the mobile phone communication module 210.

When the mobile communication terminal provides the multi-communication service by covering a plurality of counterpart terminals using the same network, the mobile communication terminal includes a plurality of communication modules to communicate with the counterpart terminals over the same network. For example, when the mobile communication terminal provides the multi-communication service for two counterpart terminals using the Internet and one counterpart terminal using the mobile phone network, the mobile communication terminal uses two Internet communication modules and one mobile phone communication module. In this situation, the mixer 224 uses a plurality of input ports and a plurality of output ports to distinguish the audio signals of the communication modules.

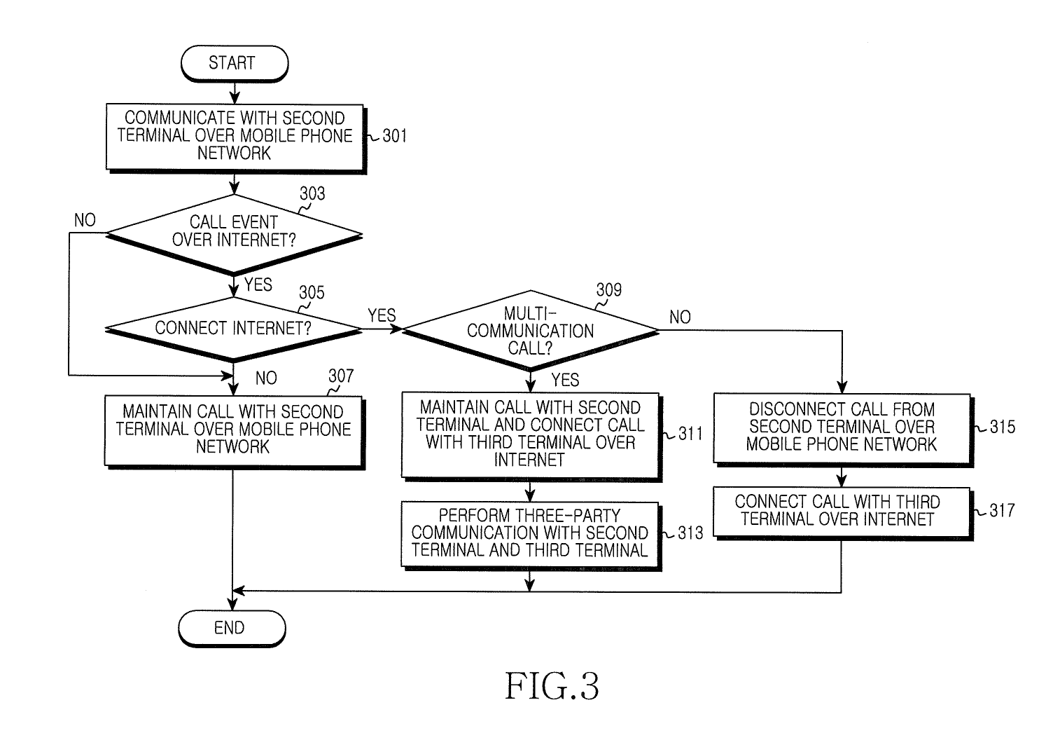

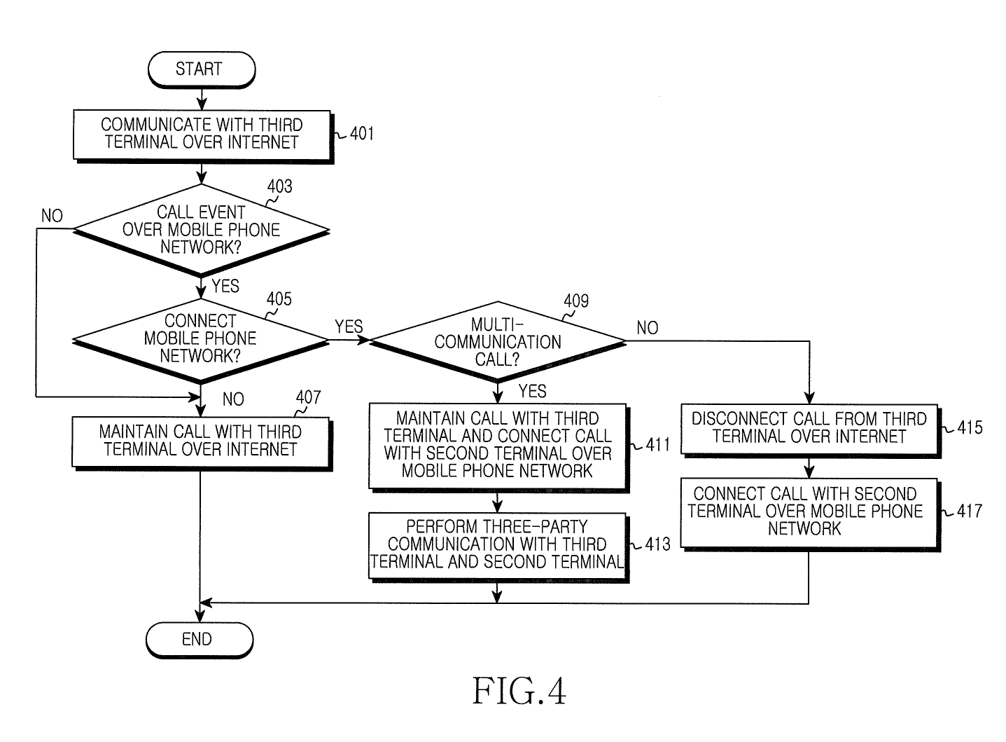

The mobile communication terminal constructed as above provides the multi-communication service as shown in FIGS. 3 and 4.

FIG. 3 illustrates a method for providing the multi-communication service in the mobile communication terminal according to an embodiment of the present disclosure.

In step 301, the mobile communication terminal communicates with the second terminal over the mobile phone network. For example, the mobile communication terminal communicates with the second terminal using the mobile phone communication module 210 of FIG. 2.

In step 303, the mobile communication terminal determines whether a call event over the Internet takes place. For example, the mobile communication terminal checks whether the third terminal requests the call over the Internet. In this situation, the mobile communication terminal displays call request information of the third terminal in a display so that the user can perceive it. For example, the mobile communication terminal checks whether the user tries to connect the call to the third terminal over the Internet.

When there is no call event over the Internet, the mobile communication terminal maintains the communication with the second terminal in step 307.

By contrast, when a call event over the Internet occurs, the mobile communication terminal determines whether to connect the call with the third terminal over the Internet in step 305. For example, the mobile communication terminal checks whether its user accepts the call connection request of the third terminal. For example, the mobile communication terminal checks whether its user requests the call connection to the third terminal.

When not connecting the call with the third terminal over the Internet, the mobile communication terminal maintains the communication with the second terminal in step 307.

By contrast, when connecting the call with the third terminal over the Internet, the mobile communication terminal determines whether to provide the multi-communication service in step 309. For example, the mobile communication terminal determines whether to use the multi-communication service with the second terminal using the mobile phone network and the third terminal using the Internet.

When using the multi-communication service, the mobile communication terminal maintains the communication with the second terminal over the mobile phone network and connects the call with the third terminal over the Internet in step 311.

After connecting the calls with the second terminal and the third terminal, the mobile communication terminal performs the multi-communication service with the second terminal and the third terminal in step 313. For example, the mobile communication terminal combines the audio signals output from the second terminal and the third terminal using the mixer 224 and sends the combined audio signal to the user through the speaker 230. The mixer 224 generates the signal to send to the third terminal by combining the audio signal fed through the microphone 240 and the audio signal fed from the second terminal. The mixer 224 generates the signal to send to the second terminal by combining the audio signal fed through the microphone 240 and the audio signal fed from the third terminal.

When not using the multi-communication service in step 309, the mobile communication terminal disconnects the call from the second terminal over the mobile phone network in step 315.

In step 317, the mobile communication terminal communicates with the third terminal by connecting the call with the third terminal over the Internet.

Next, the mobile communication terminal finishes this process.

FIG. 4 illustrates a method for providing a multi-communication service in the mobile communication terminal according to another embodiment of the present disclosure.

In step 401, the mobile communication terminal communicates with the third terminal over the Internet. For example, the mobile communication terminal communicates with the third terminal using the Internet communication module 200 of FIG. 2.

In step 403, the mobile communication terminal determines whether a call event over the mobile phone network takes place. For example, the mobile communication terminal checks whether the second terminal requests the call over the mobile phone network. In this situation, the mobile communication terminal displays call request information of the second terminal in the display so that the user can perceive it. For example, the mobile communication terminal checks whether the user tries to connect the call to the second terminal over the mobile phone network.

When there is no call event over the mobile phone network, the mobile communication terminal maintains the communication with the third terminal in step 407.

By contrast, when a call event over the mobile phone network occurs, the mobile communication terminal determines whether to connect the call with the second terminal over the mobile phone network in step 405. For example, the mobile communication terminal checks whether its user accepts the call connection request of the second terminal. For example, the mobile communication terminal checks whether its user requests the call connection to the second terminal.

When not connecting the call with the second terminal over the mobile phone network, the mobile communication terminal maintains the communication with the third terminal in step 407.

By contrast, when connecting the call with the second terminal over the mobile phone network, the mobile communication terminal determines whether to provide the multi-communication service in step 409. For example, the mobile communication terminal determines whether to use the multi-communication service with the third terminal using the Internet and the second terminal using the mobile phone network.

When using the multi-communication service, the mobile communication terminal maintains the communication with the third terminal over the Internet and connects the call with the second terminal over the mobile phone network and in step 411.

After connecting the calls with the second terminal and the third terminal, the mobile communication terminal performs the multi-communication service with the second terminal and the third terminal in step 413. For example, the mobile communication terminal combines the audio signals output from the second terminal and the third terminal using the mixer 224 and sends the combined audio signal to the user through the speaker 230. The mixer 224 generates the signal to send to the third terminal by combining the audio signal fed through the microphone 240 and the audio signal fed from the second terminal. The mixer 224 generates the signal to send to the second terminal by combining the audio signal fed through the microphone 240 and the audio signal fed from the third terminal.

When not using the multi-communication service in step 409, the mobile communication terminal disconnects the call from the third terminal over the Internet in step 415.

In step 417, the mobile communication terminal communicates with the second terminal by connecting the call with the second terminal over the mobile phone network.

Next, the mobile communication terminal finishes this process.

In another embodiment, the mobile communication terminal provides the multi-communication service using the heterogeneous networks.

Alternatively, the mobile communication terminal may provide the same multi-communication service with a plurality of counterpart terminals using the homogeneous network. In this situation, the mobile communication terminal includes a plurality of communication modules for communicating with the counterpart terminals respectively.

As set forth above, as the mobile communication terminal provides the multi-communication service with the counterpart terminals using the heterogeneous networks, the multi-communication service is available without using a separate server and with the counterpart terminals using the different networks.

The methods according to those exemplary embodiments as described in the claims and/or the specification of the present disclosure can be embodied as hardware, software, or in combination of the hardware and the software.

As for the software, a computer-readable storage medium for storing one or more programs (software modules) can be provided. One or more programs stored to the computer-readable storage medium are executable by one or more processors of an electronic device. One or more programs include instructions making the electronic device execute the methods according to the exemplary embodiments as described in the claims and/or the specification of the present disclosure.

Such programs (software module, software) can be stored to a random access memory, a non-volatile memory including a flash memory, a Read Only Memory (ROM), an Electrically Erasable Programmable ROM (EEPROM), a magnetic disc storage device, a compact disc ROM, a digital versatile disc or other optical storage devices, and a magnetic cassette. Alternatively, the programs can be stored to a memory combining part or all of those recording media. A plurality of memories may be equipped.

The programs can be stored to an attachable storage device of the electronic device accessible via the communication network such as Internet, intranet, LAN, WLAN, or SAN, or a communication network by combining the networks. The storage device can access the electronic device through an external port.

A separate storage device in the communication network may access a portable electronic device.

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

What is claimed is:

1. An apparatus for providing a multi-communication service in a mobile communication terminal, the apparatus comprising:
a microphone configured to input an audio signal;
a speaker configured to output an audio signal;
a plurality of communication modules configured to transmit and receive signals to and from a plurality of counterpart terminals; and
an audio processor configured to, when the multi-communication service is provided, combine and output a plurality of audio signals fed from the counterpart terminals providing the multi-communication service and the audio signal input through the microphone.

2. The apparatus of claim 1, wherein the audio processor comprises:
an audio codec configured to convert voice data fed from the communication modules to an audio signal and convert audio signals to send to the communication modules, to voice data; and
a mixer configured to combine at least two of the audio signals received from the counterpart terminals providing the multi-communication service and the audio signal input through the microphone.

3. The apparatus of claim 2, wherein the mixer is connected to the audio codec through a plurality of ports, and is configured to transmit and receive signals of the communication modules through the ports respectively.

4. The apparatus of claim 1, wherein the communication modules comprise:
at least one Internet communication module configured to transmit and receive signals to and from at least one first terminal over the Internet; and
at least one mobile phone communication module configured to transmit and receive signals to and from at least one second terminal over a mobile phone network.

5. The apparatus of claim 4, wherein the audio processor is configured to combine a first audio signal input through the mobile phone communication module and a second audio signal input through the Internet communication module and output the combined audio signal through the speaker,
the audio processor is configured to combine the second audio signal and a third audio signal input through the microphone and transmit the combined audio signal to the at least the second terminal through the mobile phone communication module, and
the audio processor is configured to combine the first audio signal and the third audio signal and transmit the combined audio signal to the at least the first terminal through the Internet communication module.

6. The apparatus of claim 4, wherein the Internet communication module and the mobile phone communication module are independently operated.

7. The apparatus of claim 4, further comprising:
a controller configured to determine whether to provide the multi-communication service when a call event of the second terminal takes place through the Internet communication module while communicating with the first terminal through the mobile phone communication module or when a call event of the first terminal takes place through the mobile phone communication module while communicating with the second terminal through the Internet communication module.

8. The apparatus of claim 7, wherein, when determining not to provide the multi-communication service, the controller is configured to select either the first terminal or the second terminal to connect the call.

9. The apparatus of claim 7, wherein, when determining not to provide the multi-communication service, the controller is configured to control the audio processor to combine and output at least two of the audio signals received from the counterpart terminals and the audio signal input through the microphone.

10. The apparatus of claim 4, wherein the mobile phone network comprises any one of a 2 Generation (G) network, a 3G network, and a 4G network,
the Internet comprises any one of the 3G network, the 4G network, and a wireless Local Area Network (LAN),
the 2G network comprises at least one of a Code Division Multiple Access (CDMA) system and a Global System for Mobile Communications (GSM) system,
the 3G network comprises at least one of a Wideband CDMA (WCDMA) system, a CDMA 2000 system, a High Speed Downlink Packet Access (HSDPA) system, and a High Speed Uplink Packet Access (HSUPA) system, and
the 4G network comprises at least one of a Long Teen Evolution (LTE) system and a Wibro system.

11. A method for providing a multi-communication service in a mobile communication terminal, comprising:
when the multi-communication service is provided, connecting calls with a plurality of counterpart terminals using a plurality of communication modules; and
combining at least two of an audio signal input through a microphone and audio signals fed from the counterpart terminals and sending the combined audio signal to the counterpart terminals.

12. The method of claim 11, wherein the connecting of the calls comprises:
determining whether to provide the multi-communication service when a call event of a second terminal takes place through a second communication module while communicating with a first terminal through a first communication module; and
when providing the multi-communication service, connecting the call with the second terminal while maintaining the call connection with the first terminal.

13. The method of claim 12, further comprising:
when not providing the multi-communication service, selecting any one of the first terminal and the second terminal to connect the call;
when selecting the first terminal, maintaining the call connection with the first terminal; and
when selecting the second terminal, disconnecting the call from the first terminal and connecting the call with the second terminal.

14. The method of claim 12, wherein the transmitting to the counterpart terminals comprises:
combining a first audio signal received through the first communication module and a second audio signal received through the second communication module, and outputting the combined audio signal through a speaker;
combining the second audio signal and a third audio signal input through a microphone and transmitting the combined audio signal to the first terminal through the first communication module; and
combining the first audio signal and the third audio signal and transmitting the combined audio signal to the second terminal through the second communication module.

15. The method of claim 12, wherein the first communication module comprises an Internet communication module configured to transmit and receive signals to and from the first terminal over the Internet, and
the second communication module comprises a mobile phone communication module configured to transmit and receive signals to and from the second terminal over a mobile phone network.

16. The method of claim 15, wherein the mobile phone network comprises any one of a 2 Generation (G) network, a 3G network, and a 4G network,
the Internet comprises any one of the 3G network, the 4G network, and a wireless Local Area Network (LAN),
the 2G network comprises at least one of a Code Division Multiple Access (CDMA) system and a Global System for Mobile Communications (GSM) system,
the 3G network comprises at least one of a Wideband CDMA (WCDMA) system, a CDMA 2000 system, a High Speed Downlink Packet Access (HSDPA) system, and a High Speed Uplink Packet Access (HSDPA) system, and
the 4G network comprises at least one of a Long Term Evolution (LTE) system and a Wibro system.

17. The method of claim 12, wherein the first communication module comprises a mobile phone communication module configured to transmit and receive signals to and from the first terminal over a mobile phone network, and
the second communication module comprises an Internet communication module configured to transmit and receive signals to and from the second terminal over the Internet.

18. The method of claim 17, wherein the mobile phone network comprises any one of a 2G network, a 3G network, and a 4G network,
the Internet comprises any one of the 3G network, the 4G network, and a wireless LAN,
the 2G network comprises at least one of a CDMA system and a GSM system,
the 3G network comprises at least one of a WCDMA system, a CDMA 2000 system, a HSDPA system, and a HSUPA system, and
the 4G network comprises at least one of an LTE system and a Wibro system.

19. The method of claim 15, wherein the Internet communication module and the mobile phone communication module are independently operated.

20. The method of claim 12, further comprising:
determining whether to provide the multi-communication service when a call event of the second terminal takes place through an Internet communication module while communicating with the first terminal through the mobile phone communication module or when a call event of the first terminal takes place through the mobile phone communication module while communicating with the second terminal through the Internet communication module
